(19) United States
(12) Patent Application Publication
(10) Pub. No.: US 2010/0216053 A1
(43) Pub. Date: Aug. 26, 2010

(54) Stack flow path of planar solid oxide fuel cell

(75) Inventors: Yung-Neng Cheng, Taoyuan County (TW); Ruey-Yi Lee, Taoyuan County (TW); Yau-Pin Chyou, Taoyuan County (TW); Kin-Fu Lin, Taoyuan County (TW)

Correspondence Address: Jackson Intellectual Property Group PLLC, 106 Starvale Lane, Shipman, VA, 22971, US

(73) Assignee: ATOMIC ENERGY COUNCIL - INSTITUTE OF NUCLEAR ENERGY RESEARCH, Taoyuan (TW)

(21) Appl. No.: 11/822,704

(22) Filed: Jul. 9, 2007

(51) Int. Cl. H01M 8/10

(52) U.S. Cl. 429/495

(57) ABSTRACT

Through protrusion on channel area, a fuel flows higher to have a better reaction with a power generating plate of an SOFC. A material is selected for stacks to reduce the number of stacks and to simplify an assembling process of the stacks.

### FIELD OF THE INVENTION

The present invention relates to a flow path; more particularly, relates to flowing a fuel to a cathode of a power generating plate through a metal web with a good reaction efficiency and a reduced number of stacks.

### DESCRIPTION OF THE RELATED ART

A general solid oxide fuel cell (SOFC) is shown in FIG. 7, comprising a first and a second connecting plates 5,5a. A frame 6 is set between the first and the second connecting plates 5,5a; and the frame 6 has a metal web and a power generating plate 8 piled up at center. Therein, a fuel is flowed from the first connecting plate 5 to the second connecting plate 5a to be diffused into the metal web 7 for obtaining power through reacting with the power generating plate 8.

Although the general SOFC obtains power through reacting the metal web 7 with the power generating plate 8, the reacting efficiency is low owing to the slow diffusion of the fuel into the metal web 7 to be reacted with the power generating plate 8. in addition, the stack number is high and assembling process is hard. Hence, the prior art does not fulfill all users' requests on actual use.

### SUMMARY OF THE INVENTION

The main purpose of the present invention is to force a fuel to flow through a metal web to react with a power generating plate by using the power generating plate and the metal web through a design, and, thus, to improve a reaction efficiency and to reduce a number of stacks.

To achieve the above purpose, the present invention is a stack flow path of a planar SOFC, comprising an upper end plate, a lower end plate, a plurality of frame plates and a plurality of connecting plates, where the upper end plate has a fuel input pipe and an air input pipe; the lower end plate is corresponding to a surface of the upper end plate and has a fuel output pipe and an air output pipe; the frame plates are set between the upper and the lower end plates; each frame plate has a power generating plate and has an air inlet and outlet at upper side connecting to the power generating plate through a flow path; each of the connecting plates is set between two neighboring frame plates; each connecting plate has a metal web corresponding to the power generating plate and has a fuel inlet and outlet at upper side connecting to the metal web through a flow path; and the material of stack is selected for supporting the power generating plate, insulating cell units and sealing stacks to reduce a number of stacks and to simplify an assembling process of the stacks. Accordingly, a novel stack flow path of a planar SOFC is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the three-dimensional explosive view showing the preferred embodiment according to the present invention;

FIG. 2 is another three-dimensional explosive view showing the preferred embodiment;

FIG. 3 to FIG. 5 are the views showing the first, the second and the third preferred embodiments of the channel area of the connecting plate or the lower end plate;

FIG. 6 is the view showing the state of use of the present invention; and

FIG. 7 is the view of the state of use of the prior art.

### DESCRIPTION OF THE PREFERRED EMBODIMENT

The following description of the preferred embodiment is provided to understand the features and the structures of the present invention.

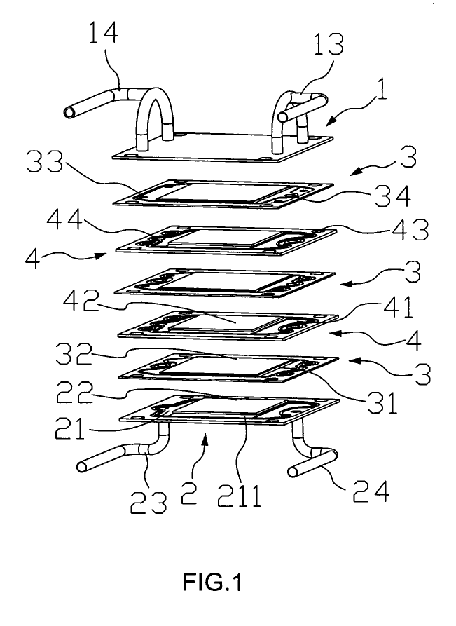

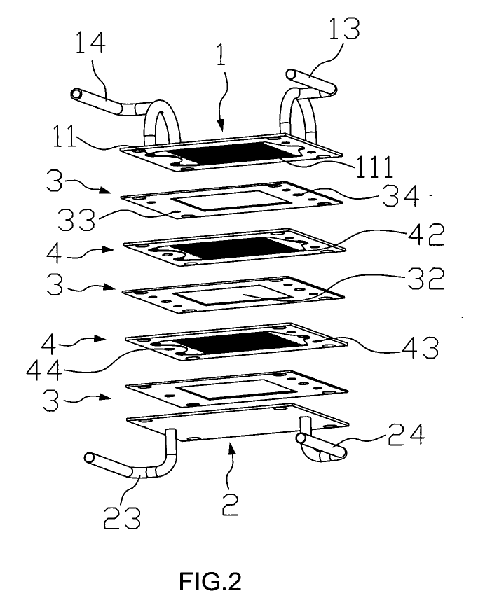

Please refer to FIG. 1 and FIG. 2, which are one and another three-dimensional (3D) explosive views showing a preferred embodiment according to the present invention. As shown in the figures, the present invention is a stack flow path of a planar solid oxide fuel cell (SOFC), comprising an upper end plate 1, a lower end plate 2, a plurality of frame plates 3 and a plurality of connecting plates 4, where, with a metal web 42 on the connecting plate 4 and, a fuel is passed through the metal web 42 to improve a reaction efficiency of a power generating plate 32 of the frame plate 3.

The upper end plate 1 has a first channel area 11 on a surface, where the first channel area 11 has a whole surface of concave trough path 111; and air flows through the concave trough path 111 from west to east. The upper end plate 1 contacts with a cathode of the power generating plate on a surface of the upper end plate 1; and the upper end plate 1 contacts with a fuel input pipe 13 and an air input pipe 14 on another surface connecting to the first channel area 11.

The lower end plate 2 is correspondingly deposed on a surface of the upper end plate 1. The lower end plate 2 has a second channel area on a surface, where the second channel area 21 has a whole surface of protrusion 211. A metal web 22 is deposed on a surface of the lower end plate 2. And the lower end plate 2 has a fuel output pipe 23 and an air output pipe 24 on another surface connecting to the second channel area 21. The metal web 22 contacts with anode of the power generating plate 32 on a surface of the metal web 22.

The frame plates 3 are piled up between the upper end plate 1 and the lower end plate 2, where each frame plate 3 has a through hole with supporting step 31 and the through hole with supporting step 31 has a power generating plate 32 within. The frame plate 3 has air inlets 33 at a side and an air outlet 34 at another side and the air inlets 33 and the air outlet 34 are connected with the power generating plate 32 through a concave trough path 111.

Each two neighboring frame plates have the connecting plate 4 in between. The connecting plate 4 has a third channel area 41 at center and a metal web 42 is deposed on the third channel area 41 corresponding to the power generating plate 32. The connecting plate 4 has fuel inlets 43 at a side and a fuel outlet 44 at another side; and, the fuel inlets 43 and the fuel outlet 44 are connected with the metal web 42 through the third channel area 41. Thus, a novel stack flow path of a planar SOFC is obtained.

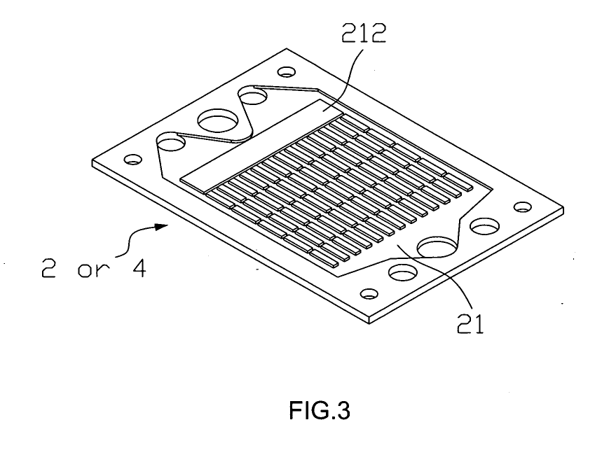

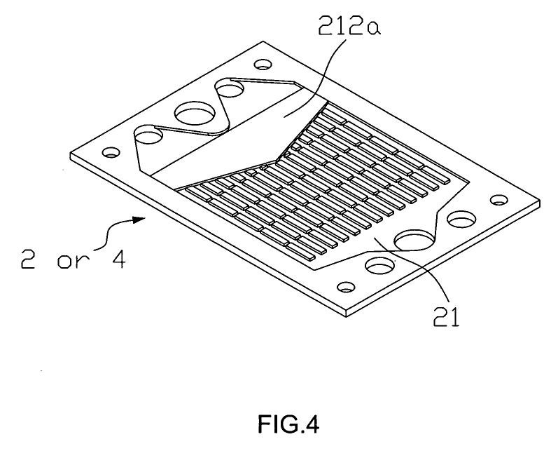

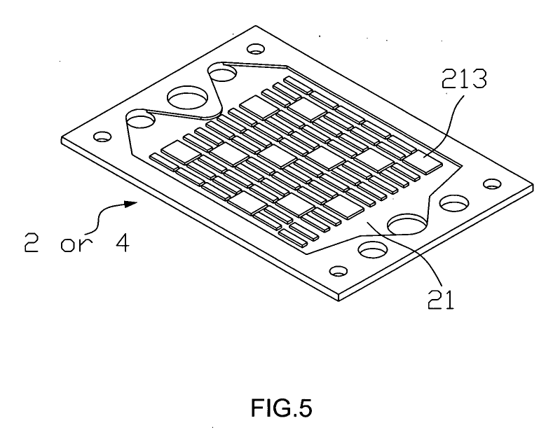

Please refer to FIG. 3 to FIG. 5, which are views showing a first, a second and a third preferred embodiments of the channel area of the connecting plate or the lower end plate. As shown in the figures, the lower end plate 2 or the connecting plate 4 has a whole surface of protrusion 211 (as shown in FIG. 1 and FIG. 2) in the second channel area 21; or, a protrusion bar 212 at a proper place across the second channel area (as shown in FIG. 3); or, a triangle or half ellipse protrusion bar 212a (as shown in FIG. 4) protruding out at center at a side of fuel inlets; or, protrusions 213 (as shown in FIG. 5) distributed at proper places in the second channel area 21. Thus, fuel in the flow path flows upward.

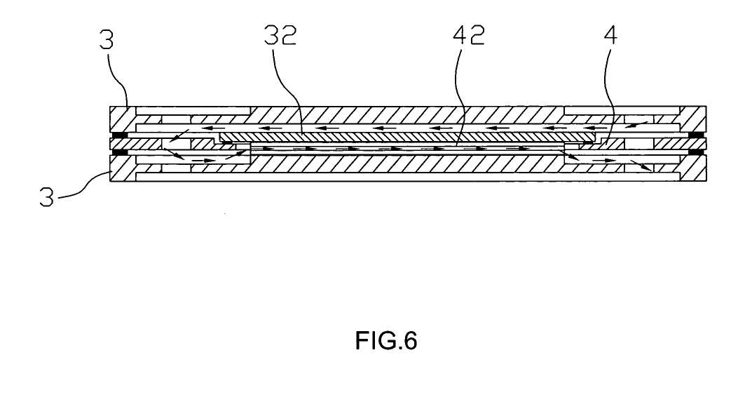

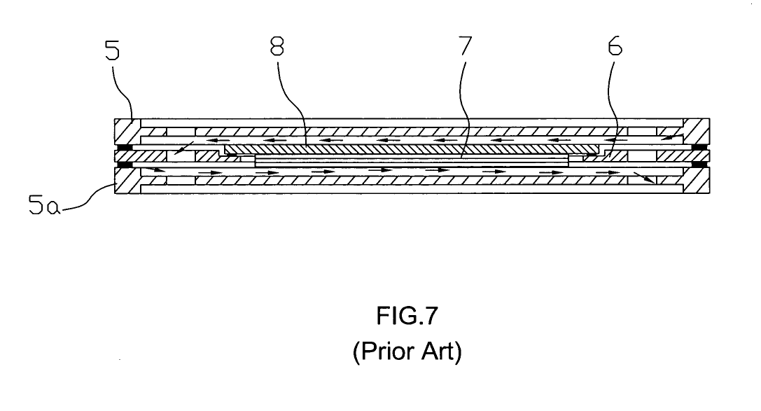

Please refer to FIG. 1 and FIG. 6, which are the 3D explosive view showing the preferred embodiment and a view showing a state of use of the present invention. As shown in the figures, on using the present invention, fuel and air enter from a fuel input pipe 13 and an air input pipe 14 of an upper end plate 1 respectively. Air flows through air inlets 33 and an air outlet 34 of a frame plate 3; and, fuel flows through fuel inlets 43 and a fuel outlet 44 of a connecting plate 4. When the fuel flows from the fuel inlets 43 to the fuel outlet 44 in the connecting plate 4, the fuel is directly guided to the metal web 42 in the third channel area and then is flowed out from the fuel outlet 44 to the next frame plate 3. The fuel is directly reacted with the power generating plate 32 of the frame plate 3 through the metal web 42 on the connecting plate 4. Thus, the fuel flows to the metal web 42 to react with the power generating plate 32 for obtaining a good power generating efficiency by improving a reaction efficiency of the fuel between the metal web 42 and the power generating plate 32.

Concerning stack material, the frame plate 3 and the connecting plate usually use metals and ceramics. Besides, an insulating material has to be used between the frame plate 3 and the connecting plate 4 to avoid electricity conductivity; and the frame plate 3 and the connecting plate 4 have to be sealed to avoid working fluid from leakage. Thus, a sealing and insulating material used here is mainly mica or glass-ceramic glue. Yet, mica is worse in airtightness than glass-ceramic glue so that a mixture of mica and glass-ceramic glue is used as a material for a frame plate to support a power generating plate, to insulate cell units and to seal stacks. The mixture of mica and glass-ceramic glue is obtained through an infiltration by dipping, through forming by a combined powder metallurgy, or through other method for obtaining the same compound material. Thus, a number of stacks is reduced and an assembling process of the stacks is simplified.

To sum up, the present invention is a stack flow path of a planar SOFC, where a frame plate, a power generating plate on a connecting plate, and a metal web are used to force a fuel to flow through a metal web to an anode of the power generating plate for obtaining a good reaction efficiency and for simplifying a stack assembling process.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A stack flow path of a planar solid oxide fuel cell (SOFC), comprising
an upper end plate, said upper end plate having a first channel area on a surface of said upper end plate, said upper end plate having a fuel input pipe and an air input pipe separately deposed at two sides on another surface of said upper end plate, said fuel input pipe and said air input pipe connecting to said first channel area;
a lower end plate, said lower end plate corresponding to a surface of said upper end plate, said lower end plate having a second channel area on a surface of said lower end plate, a metal web being deposed on said second channel area, said lower end plate having a fuel output pipe and an air output pipe separately deposed at two sides on another surface of said lower end plate, said fuel output pipe and said air output pipe connecting to said second channel area;
a plurality of frame plates, said frame plates being located between said upper end plate and said lower end plate, said frame plate having a power generating plate and a metal web at center, said frame plate separately having an air inlet and an air outlet at two sides of said frame plate, said air inlet and said air outlet being connected with said power generating plate through a flow path; and
a plurality of connecting plates, each of said connecting plates being located between two neighboring said frame plates, said connecting plate having a metal web corresponding to said power generating plate, said connecting plate having a fuel inlet and a fuel outlet at two sides of said connecting plate separately, said fuel inlet and said fuel outlet being connected with said metal web through said flow path.

2. The stack flow path according to claim 1,
wherein said frame plate is made of a material selected from a group consisting of a metal or a ceramic.

3. The stack flow path according to claim 1,
wherein said frame plate is made of mica to support said power generating plate, to insulate cell units, and to seal stacks.

4. The stack flow path according to claim 3,
wherein said mica is mixed with a material to strengthen said sealing and said material is selected from a group consisting of a glass and a ceramic.

5. The stack flow path according to claim 4,
wherein said mica is mixed through a method to obtain a compound material selected from a group consisting of infiltrating by dipping and forming by a combined powder metallurgy.

6. The stack flow path according to claim 1,
wherein a third channel area of said connecting plate and said second channel area have a whole surface of protrusions.

7. The stack flow path according to claim 1,
wherein a third channel area of said connecting plate and said second channel area have at least one protrusion bar.

8. The stack flow path according to claim 1,
wherein a third channel area of said connecting plate and said second channel area have at least one protrusion bar; and
wherein said protrusion bar is protruded at center at a side of said fuel inlet to obtain a shape selected from a group consisting of a triangle and a half ellipse.

9. The stack flow path according to claim 1,
wherein a third channel area of said connecting plate and said second channel area of said lower end plate are distributed with a plurality of protrusions.

10. The stack flow path according to claim 1,
wherein said frame plate has a hole at center of said frame plate to depose said power generating plate and said metal web; and
wherein said hole is connected with said flow path.
